(19) United States
(12) Patent Application Publication
(10) Pub. No.: US 2026/0305615 A1
(43) Pub. Date: Oct. 8, 2026

(54) COMPOSITIONS AND METHODS FOR CONTROLLING PLANT PATHOGENS

(71) Applicant: Kannar Earth Science, Ltd., Lawrenceville, GA (US)

(72) Inventors: Justin KWIATKOWSKI, Atlanta, GA (US); Samuel L. Cloete, Suwanee, GA (US)

(21) Appl. No.: 19/148,538

(22) PCT Filed: Jan. 18, 2024
(86) PCT No.: PCT/US2024/011966

§ 371 Date: Jul. 16, 2025

Related U.S. Application Data
(60) Provisional application No. 63/480,621, filed on Jan. 19, 2023.

(51) Int. Cl. A01N 63/22; A01N 25/14; A01N 37/26; A01N 43/50; A01N 43/54; A01N 43/653; A01N 43/84; A01N 47/14; A01N 53/00; A01P 3/00; A01P 7/04

(52) U.S. Cl. CPC A01N 63/22; A01N 25/14; A01N 37/26; A01N 43/50; A01N 43/54; A01N 43/653; A01N 43/84; A01N 47/14; A01N 53/00; A01P 3/00; A01P 7/04

(57) ABSTRACT

A strain of Bacillus haynesii (B. haynesii NRRL B-41327) has been discovered to have a surprisingly high level of antifungal activity. In vitro fungicidal experiments show that when grown in the presence of White mold (Sclerotium rolfsii), Fusarium oxysporum, or Aspergillus niger, the strain completely inhibits the growth of the fungus. Accordingly, compositions including B. haynesii NRRL B-41327 are provided for use in methods for controlling pathogen damage to plants. Compositions including the B. haynesii strain can be seed-applied, foliage-applied, used in-furrow, applied to soil or growth medium surrounding a plant, or applied on plant tips or roots to grow along with plants to protect from pathogens and enhance growth and productivity in the presence of plant pathogens.

### CROSS-REFERENCE TO RELATED APPLICATIONS

This application claims priority to U.S. Provisional Patent Application No. 63/480,621 filed on Jan. 19, 2023, which is incorporated by reference herein in its entirety.

### FIELD OF INVENTION

The present invention relates to use of a microbial composition for controlling plant pathogens and enhancing crop yield. More specifically, the present invention relates to applying to the plant, a seed from which the plant is grown, or to an environment in which the plant is grown, a composition comprising a microbial strain.

### BACKGROUND

Largely because of the desire to replace synthetic fertilizers and chemical pesticides to improve crop health and limit negative environmental impacts, interest in biological products for control of pests in agriculture has increased recently. Research has demonstrated the economic benefits of biological products and credible performance in integrated crop management systems. Microbial products are one category of biological products derived from naturally occurring microorganisms such as bacteria and fungi. These products are live, microbial strains that can be seed-applied, used in-furrow, or sprayed on crops to grow along with plants to protect from pests and diseases, or to enhance plant productivity and fertility. Microbial products offer the potential to deliver sustainable, cost-effective solutions that can help increase yield while using less input. However, there remains much to develop in control of plant pests with microbials given that existing microbials are insufficient to address the serious, worldwide threat to crops from plant pathogens.

Thus, there is an unmet need for improved microbials that can reduce crop damage from plant pathogens without the toxic effects of chemical pesticides. The present disclosure provides such an improved microbial and methods of its application to reduce damage from pathogens and improve plant health and crop yields.

### SUMMARY

In one embodiment of the invention, a method is provided for controlling pathogen damage to a plant, the method comprising: planting a plant or a seed of a plant in a suitable growth medium, the plant or the seed having a coating or partial coating of a composition comprising: a biologically pure culture of a Bacillus haynesii NRRL B-41327, or a mutant thereof having all the identifying characteristics thereof. Optionally, the composition comprises one or more carriers, excipients, nutrients, plant growth regulators, or microbial-, biological-, or chemical-crop protection agents. The Bacillus haynesii NRRL B- 41327 is present in the composition in an amount suitable to improve plant yield or reduce plant pathogen damage in the presence of a plant pathogen, or both.

In another embodiment, a method is provided for controlling pathogen damage to a plant, the method comprising: delivering to seed of a plant, foliage of a plant, roots of a plant, or soil or growth medium surrounding a plant, a composition comprising: a biologically pure culture of a Bacillus haynesii NRRL B-41327, or a mutant thereof having all the identifying characteristics thereof. Optionally, the composition comprises one or more carriers, excipients, nutrients, plant growth regulators, or microbial-, biological-, or chemical-crop protection agents. The Bacillus haynesii NRRL B-41327 is present in the composition in an amount suitable to improve plant yield or reduce plant pathogen damage in the presence of a plant pathogen, or both.

In another instance, a method is provided of plant or plant seed treatment comprising applying to a plant or seeds of a plant a coating of a composition comprising: a biologically pure culture of a Bacillus haynesii NRRL B-41327, or a mutant thereof having all the identifying characteristics thereof. Optionally, the composition comprises one or more carriers, excipients, nutrients, plant growth regulators, or microbial-, biological-, or chemical-crop protection agents. The Bacillus licheniformis K-357 is present in the composition in an amount suitable to improve plant yield or reduce plant pathogen damage in the presence of a plant pathogen, or both.

In a further embodiment, a plant or a seed of a plant is provided having a coating of a composition comprising: a biologically pure culture of a Bacillus haynesii NRRL B-41327 or a mutant thereof having all the identifying characteristics thereof. Optionally, the composition comprises one or more carriers, excipients, nutrients, plant growth regulators, or microbial-, biological -or chemical-crop protection agents. The Bacillus haynesii NRRL B-41327 is present in the composition in an amount suitable to improve plant yield or reduce plant pathogen damage in the presence of a plant pathogen, or both.

In the methods and compositions of the invention, the composition can be in the form of a dust, a dry wettable powder, a spreadable granule, or a dry wettable granule and the Bacillus haynesii NRRL B-41327 can be present in an amount ranging from 1.0×10¹² CFU/g to 1.0×10¹⁰ CFU/g, from 5.0×10¹¹ CFU/g to 1.0×10³ CFU/g, or from 1.25×10¹¹ CFU/g to 1.0×10⁸ CFU/g. In another instance, the composition can be in the form of a liquid and the Bacillus haynesii NRRL B-41327 can be present in the composition at a concentration ranging from 1.0×10¹² to 1.0×10¹ CFU/ml, 1.0×10¹¹ CFU/ml to 1.0×10² CFU/ml, or from 1.0×10¹⁰ CFU/ml to 1.0×10⁴ CFU/ml.

The Bacillus haynesii NRRL B-41327 can be applied to the seed or present on the seed in an amount ranging from 1.0×10¹² CFU/g to 1.0×10¹ CFU/g, from 9.0×10⁷ CFU/g to 2.0×10⁴ CFU/g, or from 4.0×10⁸ CFU/g to 1.0×10⁴ CFU/g seed.

In the methods and compositions of the invention, the coating of the composition can be applied to or present on the plant foliage, the plant root tips, or the plant transplant roots.

The crop protection agents of the methods and compositions of the invention can include one or a combination of Imidacloprid, Bifenthrin, Metalaxyl, Tebuconazole, Azoxystrobin, Carboxin, Thiram, Fludioxonil, Myclobutanil, Mefenoxam, Sedaxane, Thiamethoxam, Ipconazole or Abamectin.

The plant or seed of the plant of the present invention can include one or more of corn vegetables, monocots, dicots, cotton, rice, soybean, tomato, cereals, root/tuber and brassica vegetables, cucurbit vegetables, bulb vegetables, citrus, fruiting vegetables, herbs/spices, leafy vegetables, legumes/vegetables (succulent and dried beans and peas), oil seed crops, sunflower, pome fruit, stone fruit, strawberry, sugarcane, sugarbeet, tree nuts, kiwi, banana, grass, ornamental plants, or hardwood cuttings. In another instance, the plant or seed can comprise peanut plants.

In the methods and compositions of the invention, the pathogen can comprise plant pathogenic fungi, plant pathogenic nematodes, Meloidogyne incognita, Heterodera glycines (SCN), Rotylenchulus reniformis, Lesion nematode, corn rootworm, western corn rootworm (WCR), northern corn rootworm (NCR), southern corn rootworm (SCR), aphids, Green peach aphid (Myzus persicae), or Cotton aphid (Aphis gossypii), and combinations thereof. In some instances, the pathogen comprises plant pathogenic fungi. In other instances, the pathogen comprises Sclerotium rolfsii, Fusarium oxysporum, or Aspergillus niger.

### BRIEF DESCRIPTION OF THE DRAWINGS

The features and advantages of the present invention will be more clearly understood from the following description taken in conjunction with the accompanying drawings. The accompanying Figures are provided by way of illustration and not by way of limitation. The foregoing aspects and other features of the disclosure are explained in the following description, taken in connection with the accompanying example figures (also “FIG.”) relating to one or more embodiments.

FIG. 1 is an image showing the ability of B. haynesii NRRL B-41327 to control Fusarium oxysporum in an in vitro fungicidal test.

FIG. 2 is an image showing the ability of B. haynesii NRRL B-41327 to control White mold fungus (Sclerotium rolfsil) collected from greenhouse grown peanut roots in an in vitro fungicidal test.

FIG. 3 is an image showing the ability of B. haynesii NRRL B-41327 to control Aspergillus niger in an in vitro fungicidal test.

### DETAILED DESCRIPTION

For the purposes of promoting an understanding of the principles of the present disclosure, reference will now be made to preferred embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Unless otherwise indicated, technical and scientific terms used herein have the same meaning as commonly understood by those of ordinary skill in the art to which this disclosure belongs.

Due to a desire to replace or reduce synthetic fertilizers and chemical pesticides to improve crop health and limit negative environmental impacts, a live, microbial strain, and compositions comprising, and seeds and plants coated therewith, are herein provided to control plant pests and/or pathogens including plant pathogenic fungi. Research has demonstrated the economic benefits of such live, microbial products and credible performance in integrated crop management systems. The live, microbial strain provided herein can be seed-applied, foliage-applied, used in-furrow, applied to soil or growth medium surrounding a plant, or applied on plant tips or roots to grow along with plants to protect from pathogens and enhance growth and productivity. The live, microbial compositions and associated methods provided herein offer the potential to deliver sustainable, cost-effective solutions that can increase yield with less input, while avoiding the toxic effects on users and the environment associated with chemical alternatives.

B. haynesii NRRL B-41327, originally isolated from soil in the Southern Negev desert, was obtained from the NRRL culture collection. The present inventors discovered that this strain of B. haynesii has a surprisingly high level of antifungal activity. For example, in vitro fungicidal experiments described in Example 1 show that when grown in the presence of either White mold (Sclerotium rolfsil) collected from greenhouse grown peanuts or Fusarium oxysporum, the strain completely inhibits the growth of the fungus.

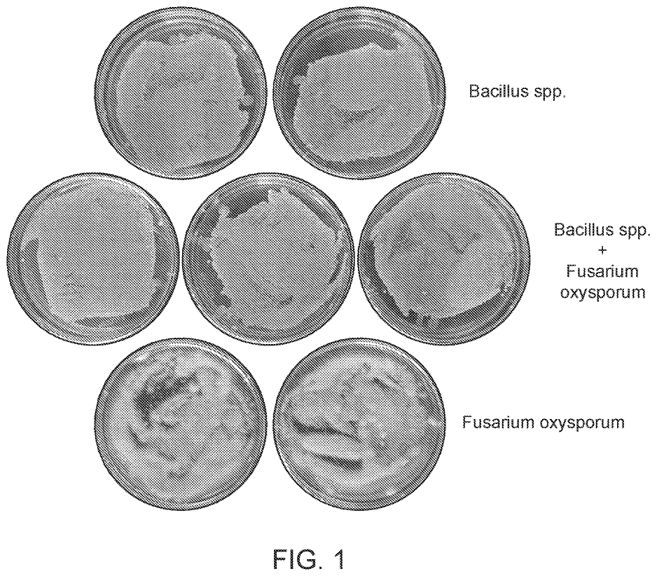

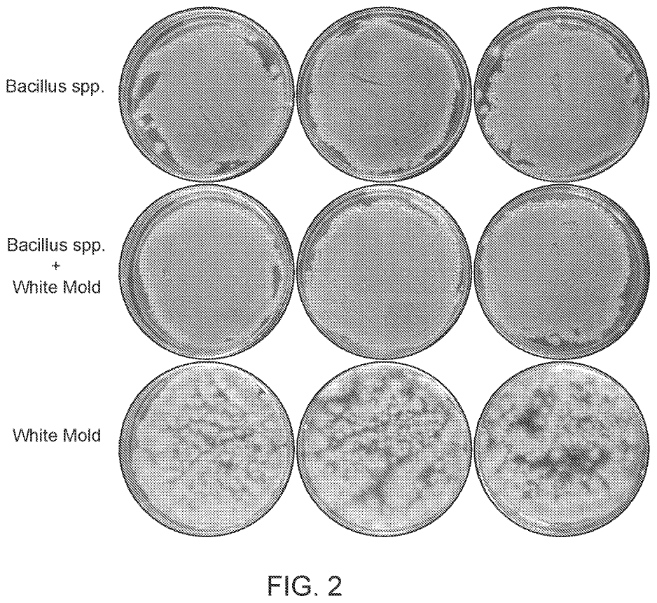

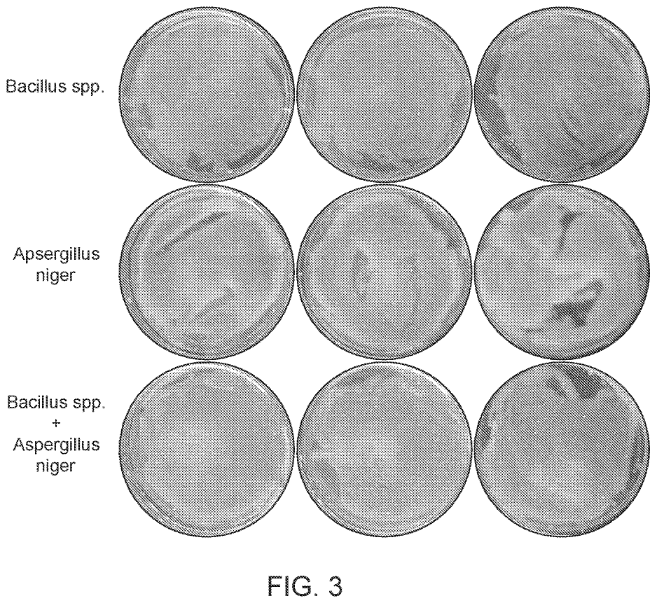

The results of the experiments described in Example 1 with Fusarium oxysporum are shown in FIG. 1, the results with White mold are shown in FIG. 2, and the results with Aspergillus niger in FIG. 3. As can be seen in the images in the FIG. 1, the addition of Bacillus haynesii to the growth media containing the White mold, Fusarium oxysporum, or Aspergillus niger completely inhibited the growth of the fungus in all the experiments. Specifically, the petri dishes containing the B. haynesii alone (top row of both FIG. 1 and FIG. 2) are indistinguishable from the petri dishes containing the B. haynesii in combination with the fusarium (middle row of FIG. 1) or the White mold (middle row of FIG. 2). This is in contrast to the plates inoculated with either White mold (bottom row of FIG. 1) or Fusarium oxysporum (bottom row of FIG. 2) alone where fungal growth has proliferated. In FIG. 3, the petri dishes containing the B. haynesii alone (top row) are indistinguishable from the petri dishes containing the B. haynesii in combination with the aspergillus niger (bottom row). In contrast, fungal growth has proliferated in the plates inoculated with Aspergillus niger alone (middle row).

Accordingly, compositions including B. haynesii NRRL B-41327 can be useful in methods for controlling pathogen damage to a plant.

For example, in one embodiment, a method is provided for controlling pathogen damage to a plant, the method comprising: planting a plant or a seed of a plant in a suitable growth medium, the plant or the seed having a coating or partial coating of a composition consisting of, consisting essentially of, or comprising: a biologically pure culture of a Bacillus haynesii NRRL B-41327, or a mutant thereof having all the identifying characteristics thereof. Optionally, the composition comprises one or more carriers, excipients, nutrients, plant growth regulators, or microbial-, biological-, or chemical-crop protection agents. In the method, the Bacillus haynesii NRRL B-41327 is present in the composition in an amount suitable to improve plant yield or reduce plant pathogen damage in the presence of a plant pathogen, or both.

What is meant by “a composition consisting essentially of” a biologically pure culture of a Bacillus haynesii NRRL B-41327, or a mutant thereof having all the identifying characteristics thereof, is that the Bacillus haynesii strain is the only component in the composition for controlling pathogen damage to a plant. For example, the compositions of the invention consisting essentially of a biologically pure culture of a Bacillus haynesii NRRL B-41327, or a mutant thereof having all the identifying characteristics thereof, may also include one or more additional components if the one or more additional components are not microbial-, biological-, or chemical-crop protection agents against plant pests and/or plant pathogens such as, for example, biocides, insecticides, nematicides, or fungicides. More specifically, the compositions consisting essentially of a biologically pure culture of a Bacillus haynesii NRRL B-41327, or a mutant thereof having all the identifying characteristics thereof, may optionally also comprise one or more carriers, excipients, nutrients, or plant growth regulators.

In another instance, a method is provided for controlling pathogen damage to a plant, the method comprising: delivering to seed of a plant, foliage of a plant, roots of a plant, or soil or growth medium surrounding a plant, a composition consisting of, consisting essentially of, or comprising: a biologically pure culture of a Bacillus haynesii NRRL B-41327, or a mutant thereof having all the identifying characteristics thereof. Optionally, the composition comprises one or more carriers, excipients, nutrients, plant growth regulators, or microbial-, biological-, or chemical-crop protection agents. In the method, the Bacillus haynesii NRRL B-41327 is present in the composition in an amount suitable to improve plant yield or reduce plant pathogen damage in the presence of a plant pathogen, or both.

In the methods for controlling pathogen damage to a plant, the Bacillus haynesii NRRL B-41327 can be present on the seed in an amount ranging from 1.0×10¹² CFU/g to 1.0×10¹ CFU/g, from 9.0×10⁷ CFU/g to 2.0×10⁴ CFU/g, or from 4.0×10⁸ CFU/g to 1.0×10⁴ CFU/g seed.

in the methods provided herein, the composition can be in the form of a liquid and the Bacillus haynesii NRRL B-41327 can be present at a concentration ranging from 1.0×10¹² to 1.0×10¹ CFU/ml, 1.0×10¹¹ CFU/ml to 1.0×10² CFU/ml, or from 1.0×10¹⁰ CFU/ml to 1.0×10⁴ CFU/ml in the composition. The composition can be in the form of a dust, a dry wettable powder, a spreadable granule, or a dry wettable granule and the Bacillus haynesii NRRL B-41327 can be present in an amount ranging from 1.0×10¹² CFU/g to 1.0×10¹⁰ CFU/g, from 5.0×10¹¹ CFU/g to 1.0×10³ CFU/g, or from 1.25×10¹¹ CFU/g to 1.0×10⁸ CFU/g in the composition.

Another embodiment of the invention is a method of plant or plant seed treatment comprising applying to a plant or seeds of a plant a coating of a composition consisting of, consisting essentially of, or comprising: a biologically pure culture of a Bacillus haynesii NRRL B-41327, or a mutant thereof having all the identifying characteristics thereof. Optionally, the composition comprises one or more carriers, excipients, nutrients, plant growth regulators, or microbial-, biological-, or chemical-crop protection agents. In the method, the Bacillus licheniformis K-357 is present in the composition in an amount suitable to improve plant yield or reduce plant pathogen damage in the presence of a plant pathogen, or both.

The coating can be applied to the plant foliage, the plant root tips, or the plant transplant roots.

The Bacillus haynesii NRRL B-41327 can be applied to the seed in an amount ranging from 1.0×10¹² CFU/g to 1.0×10¹ CFU/g, from 9.0×10⁷ CFU/g to 2.0×10⁴ CFU/g, or from 4.0×10⁸ CFU/g to 1.0×10⁴ CFU/g seed.

In addition, a plant or a seed of a plant is provided that has a coating of a composition consisting of, consisting essentially of, or comprising: a biologically pure culture of a Bacillus haynesii NRRL B-41327 or a mutant thereof having all the identifying characteristics thereof. Optionally, the composition comprises one or more carriers, excipients, nutrients, plant growth regulators, or microbial-, biological- or chemical-crop protection agents. The Bacillus haynesii NRRL B-41327 is present in the composition in an amount suitable to improve plant yield or reduce plant pathogen damage in the presence of a plant pathogen, or both. The Bacillus haynesii NRRL B-41327 can be present on the seed in an amount ranging from 1.0×10¹² CFU/g to 1.0×10¹ CFU/g, from 9.0×10⁷ CFU/g to 2.0×10⁴ CFU/g, or from 4.0×10⁸ CFU/g to 1.0×10⁴ CFU/g seed.

Further, in one or more embodiments, suitable crop protection agents including insecticides, fungicides, and nematicides of the compositions and methods of the present invention may include:

Insecticide: AO) agrigata, al-phosphide, ambriseius, apherinus, aphidinus, aphidletes, artemisinin, autographa californica NPV, azocyclotin, bacillus-subtilis, bacillus subtilis Thuringiensis Izawai (bacillus-thur.-aizawai), Bacillus thuringiensis kurstakey (bacillus-thur.-kurstaki), Bacillus thuringiensis, beauveria, beauveria-bassiana ), Beta-cyfluthrin, biologics, bislutap, broflutrinate, bromophos-e, bromopropylate, Bt transgenic corn, Bt transgenic soybean, capsaicin, cartap, celastru s) Extract, Chloranthraniprole, Chlorbenzuron, Chlorethoxyphos, Chlorfluazuron, Chlorpyrifos-e, Cinidiadin, Cryolite, Cyanophos, Cyantraniprolol, Cyhalothrin, Cihexatin, Cypermethrin, Dakunusa, DCIP, Dichloropropene, Dicophor, Digliphas, Digliphas+Dakunusa, Dimetacarb, Dithioether, Dodecyl Acetate, Emamectin, Encarsia, EPN, Eretmocerus, Ethylene-dibromide, Eucalyptol, Fatty Acid, Salt, Fenazaquin, fenobucarb (BPMC), fenpyroximate, flubrocythrinate, flufensin, formethanate, formotethione, furthiocarb, gamma Cyhalothrin, garlic juice, granulosis-virus, harmonia, heliothis armigera NPV, inactive bacteria, indol-3-ylbutyric acid, iodomethane, iron, isocarbofos, isofenphos, isofenphos-m, isoprocarb, Isothioate, kaolin, lindane, liuyangmycin, matrine, mephospholane, metaaldehyde, metalidium-anisoprie, methamidophos, metorcarb (MTMC), mineral oil, milex, m-isothiocyanate, monosultap, mirotesium velcaria (Myrothecium verrucaria), nared, honey bee (neochrysocharis formos), nicotine, nicotinoid, fats and oils, oleic acid, ometoate, orius, Oxymatrine, Pesilomyces, Paraffin oil, Parathion-e, Pasteuria, Petroleum, Pheromone, Phosphate, Photolabdas, Foxime, Phytoseiulus, Pirimiphos-e, Vegetable oil, Plutella xylostella GV, Polyhedrosis virus, polyphenol extract, potassium oleate, profenofos, prosuler, prothiophos, pyracrofos, pyrethrin, pyridafenthione, pyrimidifene, pyriproxyfen, quillay extract, quinomethionate, rapeseed oil, rotenone, Saponin, saponozit, sodium compound, sodium fluorosilicate, starch, steinernema, streptomyces, sulfuramide, sulfur, tebupyrimphos Tefluthrin, temefos, tetradiphone, thiophanox, thiometone, transgenics (eg Cry3Bb1), triazamate, trichoderma, trichogranma, triflumuron, verticillium, beltrin, insecticide isomers (eg kappa-bifenthrin, kappa-tefluthrin), Dichloromesothiaz, brofuranilide, pyradiflumide, various insecticides; A1) carbamates including aldicarb, aranicarb, benfuracarb, carbaryl, carbofuran, carbosulfan, methiocarb, mesomil, oxamyl, pirimicarb, propoxur and thiodicarb; A2) Acephate, azine phos-ethyl, azine phos-methyl, chlorfenvin phos, chlorpyrifos, chlorpyrifos-methyl, de Meton-S-methyl, diazinon, dichlorvos/DDVP, dicrotophos, dimethoate, disulfotone, ethion, fenitrothion, fenthion, isoxathion, malathion, metamidaphos, methidathion, mevinphos, monocrotophos, oxymethoate, oxydemethone-methyl, parathion, parathion-methyl Organophosphates including phentoate, folate, hosalon, phosmet, phosphamidone, pyrimiphos-methyl, quinalphos, terbufos, tetrachlorbinphos, triazophos and trichlorphone; A3) cyclodiene organochloride compounds such as endosulfan; A4) ethiprole, fipronil, Fiprolols including pyrafluprole and pyriprole; A5) acetamiprid, Neonicotinoids including rotianidin, dinotefuran, imidacloprid, nitenpyram, thiacloprid and thiamethoxam; A6) spinosyns such as spinosad and spinetoram; A7) chlorids from mectins including abamectin, emamectin benzoate, ivermectin, lepimectin and milbemectin A8) Juvenile hormone mimetics such as hydroprene, quinoprene, metoprene, phenoxycarb and pyriproxyfen; A9) selective cognate feeding blockers such as pymetrozine, flonicamid and pyrifluquinazone; A10) clofentezine, hexothiazox and etoxazole A11) diafenthiuron, fenbutatin oxide and propargite Mitochondrial ATP synthase inhibitors; oxidative phosphorylation uncouplers such as chlorfenapyr; A12) nicotinic acetylcholine receptor channel blockers such as bensultap, cartap hydrochloride, thiocyclam and thiosultap sodium; A13) bistriflulone, Type 0 inhibitors of chitin biosynthesis derived from benzoylureas including diflubenzuron, flufenoxuron, hexaflumuron, lufenuron, nobarulone and teflubenzuron; A14) type 1 inhibitors of chitin biosynthesis such as buprofezin; A15) cyromazine A16) ecdysone receptor agonists such as methoxyphenozide, tebufenozide, halofenozide and chromafenozide; A17) octopamine receptors such as amitraz A18) A mitochondrial complex electron transport inhibitor pyridaben, tebufenpyrad, tolfenpyrad, flufenelim, sienopyrafen, cyflumetofene, hydramethylnon, acequinosyl or fluacrylpyrim; A19) voltage-dependent sodium channel blockers such as indoxacarb and metaflumizone; A20 ) Lipid synthesis inhibitors such as spirodiclofen, spiromesifen and spirotetramat; A21) fulvendiamide, phthalamide compound (R)-3-chloro-N1-{2-methyl-4-[1,2,2, 2-tetrafluoro-1-(trifluoromethyl) ethyl] phenyl}-N2-(1-methyl-2-methylsulfonylethyl) phthalamide and(S)-3-chloro-N1-{2-methyl-4 [1,2,2,2-tetrafluoro-1-(trifluoromethyl) ethyl] phenyl}-N2-(1-methyl-2-methylsulfonylethyl) phthalamide, chlorantraniliprole and cyantraniliprole Ryanodine receptor modulators derived from diamides including: A22) compounds with unknown or uncertain mechanisms of action such as azadirachtin, amidoflumet, biphenazate, fluenesulfone, piperonylbutoxide, pyridalyl, sulfoxaflor; or A23) acrinathrin, allethrin, bifenthrin, cyfluthrin, Lambda-cyhalothrin, cypermethrin, alpha-cypermethrin, beta-cypermethrin, zeta-cypermethrin, deltamethrin, esfenvalerate, etofenprox, phen Ropatorin, fenvalerate, flucythrinate, tau-fluvalinate, permethrin, sodium channel modulators derived pyrethroids containing silafluofen and tralomethrin.

Fungicides: B0) benzobindiflupyr, antiperonosporic, amethoctrazine, amisulbrom, copper salts (eg, copper hydroxide, copper acid chloride, copper sulfate, copper persulfate), boscalid, thiflumazide ), Fluthianyl, flaxilyl, thiabendazole, benodanyl, mepronyl, isofetamide, fenflam, bixafen, fluxapiroxad, penflufen, sedaxane, succinoxyxine, enoxastrobin, fluphenoxystrobin, pyroxystrobin, pyrame Tostrobin, Triclopyricarb, Phenamine Strobin, Metominostrobin, Pyribencarb, Meptyldinocap, Fentin acetate, Fentin chloride, Fentin hydroxide, Oxytate Cyclin, chlozolinate, chloronebu, technazen, etridiazole, iodocarb, prothiocarb, Bacillus subtilis synonym, Bacillus amyloliquefaciens (for example, QST 713, FZB 24, MBI600, D747 strain), Melaleuca altelni alternifolia extract, Lupinus albus doce extract, BLAD polypeptide, pyrisoxazole, oxpoconazole, etaconazole, fenpyrazamine, naphthifine, terbinafine, validamycin, pyrimorph, varifenalate, Phthalide, probenazole, isotianil, laminarin, Reynoutria sachalinensis extract, phosphorous acid and Salts, teclofthalam, triazoxide, pyriophenone, organic oils, potassium bicarbonate, chlorothalonil, fluoroimide; B1) bittertanol, bromconazole, cyproconazole, difenoconazole, diniconazole, enilconazole, epoxiconazole, Fluquinconazole, fenbuconazole, flusilazole, flutriazole, hexaconazole, imibenconazole, ipconazole, metconazole, microbutanyl, penconazole, propiconazole, prothioconazole, cimeconazole, triadimethone, triadimenol, tebuconazole, tetraco Nazole, triticonazole, prochloraz, pefazoate, imazalyl, triflumizole, cyazofamide, benomyl Carbendazim, thiabendazole, fuberidazole, ethaboxam, etridiazole, hymexazole, azaconazole, diniconazole-M, oxpoconazole, paclobutrazole, uniconazole, 1-(4-chlorophenyl)-2-([1,2,4] triazole- 1-yl)-azoles containing cycloheptanol and imazalyl sulfate; B2) azoxystrobin, dimoxystrobin, enestrobrin, fluoxastrobin, cresoxime-methyl, methinostrobin, orisatrobin, picoxy Strobin, pyraclostrobin, trifloxystrobin, enestrobrin, methyl (2-chloro-5-[1-(3-methylbenzyloxyimino) ethyl] benzyl) carbamate, methyl (2-c Ro-5-[1-(6-methylpyridin-2-ylmethoxyimino) ethyl] benzyl) carbamate, methyl 2-(ortho-(2,5-dimethylphenyloxymethylene)-phenyl)-3-methoxyacrylate, 2-(2-(6-(3-Chloro-2-methyl-phenoxy)-5-fluoro-pyrimidin-4-yloxy)-phenyl)-2-methoxyimino-N-methyl-acetamide and 3-methoxy-2-(2-(N-(4-Methoxy-phenyl) cyclopropanecarboximidoylsulfanylmethyl)-phenyl)-acrylic acid methyl ester strobilurin; B3) carboxin, benalaxyl, benalaxyl-M, phenhexamide, Flutolanil, furametopil, mepronil, metalaxyl, mefenoxam, Off-race, oxadixyl, oxycarboxyl, penthiopyrad, isopyrazam, tifluzamide, thiazinyl, 3,4-dichloro-N-(2-cyanophenyl) isothiazole-5-carboxamide, dimethomorph, flumorph, flumetober, fluopicolide (picobenzamide), Zoxamide, carpropamide, diclocimet, mandipropamide, N-(2-(4-[3-(4-chlorophenyl) prop-2-ynyloxy]-3-methoxyphenyl) ethyl)-2-methanesulfonyl-amino-3-methyl Butylamide, N-(2-(4-[3-(4-chlorophenyl) prop-2-ynyloxy]-3-methoxy-phenyl) ethyl)- 2-ethanesulfonylamino-3-methylbutyramide, methyl 3-(4-chloro Enyl)-3-(2-isopropoxycarbonyl-amino-3-methyl-butyrylamino) propionate, N-(4′-bromobiphenyl-2-yl)-4-difluoromethyl-methylthiazole-o-carboxamide, N-(4′-trifluoromethyl-biphenyl-2-yl)-4-difluoromethyl-2-methylthiazole-5-carboxamide, N-(4′-chloro-3′-fluorobiphenyl-2-yl)-4-Difluoromethyl-2-methyl-thiazole-5-carboxamide, N-(3,4′-dichloro-4-fluorobiphenyl-2-yl)-3-difluoro-methyl-1-methylpyrazole-4-carboxamide, N-(3′, 4′-dichloro-5-fluorobiphenyl-2-yl)-3-difluoromethyl-1-methylpyrazo Ru-4-carboxamide, N-(2-cyano-phenyl)-3,4-dichloroisothiazole-5-carboxamide, 2-amino-4-methyl-thiazole-5-carboxyanilide, 2-chloro-N-(1,1,3-trimethyl-indan-4-yl)-nicotinamide, N-(2-(1,3-dimethylbutyl)-phenyl)-1,3-dimethyl-5-fluoro-1H-pyrazole-4 Carboxamide, N-(4′-chloro-3′, 50-difluoro-biphenyl-2-yl) 3-difluoromethyl-1-methyl-1H-pyrazole-4-carboxamide, N-(4′-chloro-3′, 5-difluoro-biphenyl-2-yl)-3-trifluoromethyl-1-methyl-1H-pyrazole-4-carboxamide, N-(3′, 4′-dichloro-5-Fluoro-biphenyl-2-yl)-3-trifluoromethyl-1-methyl-1 H-pyrazole-4-carboxamide, N-(3; 5-difluoro-4′-methyl-biphenyl-2-yl)-3-Difluoromethyl-1-methyl-1H-pyrazole-4-carboxamide, N-(3′, 5-difluoro-4′-methyl-biphenyl-2-yl)-3-trifluoromethyl-1-methyl-1H-Pyrazole-4-carboxamide, N-(cis-2-bicyclopropyl-2-yl-phenyl)-3-difluoromethyl-1-methyl-1H-pyrazole-4-carboxamide, N-(trans-2-bicyclopropyl-2-yl-phenyl)-3-difluoro-methyl-1-methyl-1H-pyrazole-4-carboxamide, fluopyram, N-(3-Ethyl-3,5-5-trimethyl-cyclohexyl)-3-formylamino-2-hydroxy-benzamide, oxytetracycline, silthiophane, N-(6-methoxy-pyridin-3-yl) cyclopropanecarboxamide, 2-iodo-N-phenyl-benzamide, N-(2-bicyclo-propyl-2-yl-phenyl)-3-difluoromethyl-1-methylpyrazol-4-ylcarboxamide, N-(3′, 4′, 5′-Trifluorobiphenyl-2-yl) 1,3-dimethylpyrazol-4-ylcarboxamide, N-(3′, 4′, 5′-trifluorobiphenyl-2-yl) 1,3-dimethyl-5 Fluoropyrazol- 4-ylcarboxamide, N-(3′, 4′, 5′-trifluorobiphenyl-2-yl) 5-chloro-1,3-dimethyl-pyrazol-4-ylcarboxamide, N-(3′, 4′, 5′-trifluorobiphenyl-2-yl) 3-fluoromethyl-1-methylpyrazol-4-ylcarboxamide, N-(3′, 4′, 5′-trifluorobiphenyl-2-yl)-3- (chlorofluoromethyl)- 1-methylpyrazol-4-ylcarboxamide, N-(3′, 4′, 5′-Trifluorobiphenyl-2-yl)-3-difluoromethyl-1-methylpyrazol-4-ylcarboxamide, N-(3′, 4′, 5′-trifluorobiphenyl-2-yl)-3-difluoromethyl-5-fluoro-1-methylpyrazol-4-ylcarboxamide, N-(3′, 4′, 5′-trifluorobiphenyl-2-yl)-5-chloro-3-difluoromethyl-1-methylpyrazol-4-ylcarboxamide, N-(3′, 4′, 5′-Trifluorobiphenyl-2-yl)-3-(chlorodifluoromethyl)-1-methylpyrazol-4-ylcarboxamide, N-(3′, 4′, 5′-trifluorobiphenyl-2-yl)-1-methyl-3-trifluoromethylpyrazol-4-ylcarboxamide, N-(3′, 4′, 5′-trifluorobiphenyl-2-yl)-5-fluoro-1-methyl-3-trifluoromethyl Pyrazol-4-ylcarboxamide, N-(3′, 4′, 5′-trifluorobiphenyl-2-yl)-5-chloro-1-methyl-3-trifluoromethylpyrazol-4-ylcarboxyl N-(2′, 4′, 5′-trifluorobiphenyl-2-yl)-1,3-dimethylpyrazol-4-ylcarboxamide, N-(2′, 4′, 5′-trifluorobiphenyl)-2-yl)-1,3-dimethyl-5-fluoropyrazol-4-ylcarboxamide, N-(2′, 4′, 5′-trifluorobiphenyl-2-yl)-5-chloro-1,3-Dimethylpyrazol-4-ylcarboxamide, N-(2′, 4′, 5′-trifluorobiphenyl-2-yl)-3-fluoromethyl-1-methylpyrazol-4-ylcarboxamide, N-(2′, 4′, 5′-trifluorobiphenyl-2-yl)-3- (chlorofluoromethyl)- 1-methylpyrazol-4-ylcarboxamide, N-(2′, 4′, 5′-trifluorobiphenyl-2-yl) 3-difluoromethyl-1-methylpyrazol-4-ylcarboxamide, N-(2′, 4′, 5′-trifluorobiphenyl-2-yl)-3-difluoromethyl-5-fluoro-1-methylpyrazole-4-ylcarboxamide, N-(2′, 4′, 5′-trifluorobiphenyl-2-yl)-5-chloro-3-difluoromethyl-1-methylpyrazol-4-ylcarboxamide, N-(2′, 4′, 5′-trifluorobiphenyl-2-yl)-3-(chlorodifluoromethyl)-1-methylpyrazol-4-ylcarboxamide, N-(2′, 4′, 5′-trifluorobiphenyl-2-yl)-1-methyl-3-trifluoromethylpyrazol-4-ylcarboxamide, N-(2′, 4′, 5′-trifluorobiphenyl-2-yl)-5-fur Oro-1-methyl-3-trifluoromethylpyrazol-4-ylcarboxamide, N-(2′, 4′, 5′-trifluorobiphenyl-2-yl)-5-chloro-1-methyl-3-tri Fluoromethylpyrazol-4-ylcarboxamide, N-(3′, 4′-dichloro-3-fluorobiphenyl-2-yl)-1-methyl-3-trifluoromethyl-1H-pyrazole-4-carboxamide, N-(3′, 4′-dichloro-3-fluorobiphenyl-2-yl)-1-methyl-3-difluoromethyl-1H-pyrazole-4-carboxamide, N-(3′, 4′-difluoro-3-fluoro Biphenyl- 2-yl)-1-methyl-3-trifluoromethyl-1H-pyrazole-4-carboxamide, N-(3′, 4′-difluoro-3-fluorobiphe Ru-2-yl)-1-methyl-S-difluoromethyl-1H-pyrazole-4-carboxamide, N-(3′-chloro-4′-fluoro-3-fluorobiphenyl-2-yl)-1-methyl 3-Difluoromethyl-1H-pyrazole-4-carboxamide, N-(3′, 4′-dichloro-4-fluorobiphenyl-2-yl)-1-methyl-3-trifluoromethyl-1H-pyrazole-4 Carboxamide, N-(3′, 4′-difluoro-4-fluorobiphenyl-2-yl)-1-methyl-S-trifluoromethyl-1H-pyrazole-4-carboxamide, N-(3′, 4′-Dichloro-4-fluorobiphenyl-2-yl)-1-methyl-3-difluoromethyl-1H-pyrazole-4-carboxamide, N-(3′, 4′-difluoro-4 Fluorobiphenyl-2-yl)-1-methyl-3-difluoromethyl-1H-pyrazole-4-carboxamide, N-(3′-chloro-4′-fluoro-4-fluorobiphenyl-2-yl)-1- Methyl-S-difluoromethyl-1H-pyrazole-4-carboxamide, N-(3′, 4′-dichloro-5-fluorobiphenyl-2-yl)-1-methyl-3-trifluoromethyl-1H-pyrazole-4-carboxamide, N-(3′, 4′-difluoro-5-fluorobiphenyl-2-yl)-1-methyl-3-trifluoromethyl-1H-pyrazole-4-carboxamide, N-(3′, 4′-Dichloro-5-fluorobiphenyl-2-yl)-1-methyl-S-difluoromethyl-1H-pyrazole-4-carboxamide, N-(3′, 4-Difluoro-5-fluorobiphenyl-2-yl)-1-methyl-3-difluoromethyl-1H-pyrazole-4-carboxamide, N-(3′, 4′-dichloro-5-fluorobiphenyl-2-yl)-1,3-dimethyl-1H-pyrazole-4-carboxamide, N-(3′-chloro-4′-fluoro-5-fluorobiphenyl-2-yl)-1-methyl-3-difluoromethyl-1H-pyrazole-4-carboxamide, N-(4′-fluoro-4-fluorobiphenyl-2-yl)-1-methyl-3-trifluoromethyl-1H-pyrazole-4-carboxamide, N-(4′-fluoro-5-Fluorobibiphenyl-2-yl)-1-methyl-3-trifluoromethyl-1H-pyrazole-4-carboxamide, N-(4′-chloro-5-fur Orobiphenyl-2-yl)-1-methyl-3-trifluoromethyl-1H-pyrazole-4-carboxamide, N-(4′-methyl-5-fluorobiphenyl-2-yl)-1-methyl-3- Trifluoromethyl-1H-pyrazole-4-carboxamide, N-(4′-fluoro-5-fluorobiphenyl-2-yl)-1,3-dimethyl-1H-pyrazole-4-carboxamide, N-(4′-Chloro-5-fluorobiphenyl-2-yl)-1,3-dimethyl-1H-pyrazole-4-carboxamide, N-(4′-methyl-5-fluorobiphenyl-2-yl)-1,3-dimethyl- 1H-pyrazole-4-carboxamide, N-(4′-fluoro-6-fluorobiphenyl-2-yl)-1-methyl-3-trifluoromethyl-1H-pi Sol-4-carboxamide, N-(4′-chloro-6-fluorobiphenyl-2-yl)-1-methyl-3-trifluoromethyl-1H-pyrazole-4-carboxamide, N-[2-(1, 1,2,3,3,3-hexafluoropropoxy)-phenyl]-3-difluoromethyl-1-methyl-1H-pyrazole-4-carboxamide, N-[4′-(trifluoromethylthio)-biphenyl-2-YI]-3-difluoromethyl-1-methyl-1H-pyrazole-4-carboxamide and N-[4′-(trifluoromethylthio)-biphenyl-2-yl]-1-methyl-3-trifluoromethyl-carboxamides including 1-methyl-1H-pyrazole-4-carboxamide; B4) fluazinam, pyrifenox, bupyrimeto Prodinil, Phenarimol, Ferimzone, Mepanipyrim, Nuarimol, Pyrimethanyl, Trifolin, Fenpicuronyl, Fludioxonil, Ardimorph, Dodemorph, Fenpropimorph, Tridemorph, Fenpropidin, Iprodione, Procimidone, Vinclozoline, Famoxadone, Fenamiden, Octopronone-Azole, 5-chloro-7-(4-methylpiperidin-1-yl)-6-(2,4,6-trifluorophenyl)-[1,2,4] triazolo [1,5-a] pyrimidine, Anilazine, dichromedin, pyroxylone, proquinazide, tricyclazole, 2-butoxy-6-iodo-3-propylchromen-4-one, acibenzoral-S-methyl, captahol, captan, dazome, Holpet, phenoxanyl, quinoxyphene, N,N-dimethyl-3-(3-bromo-6-fluoro-2-methylindole-1-sulfonyl)-[1,2,4] triazole-1-sulfonamide,-Ethyl-6-octyl-[1,2,4] triazolo [1,5-a] pyrimidine-2,7-diamine, 2,3,5,6-tetrachloro-4-methanesulfonyl-pyridine, 3, 4,5-trichloropyridine-2,6-di-carbonitrile, N-(1-(5-bromo-3-chloro-pyridin-2-yl)-ethyl)-2,4-dichloronicotinamide, N-((5-Bromo-3-chloropyridin-2-yl)-methyl)-2,4-dichloro-nicotinamide, diflumetrim, nitrapirine, dodemorph acetate, fluoroimide Heterocyclic compounds including blasticidin-S, quinomethionate, debacarb, diphenzoquat, diphenzoquat-methylsulfate, oxophosphate and piperalin; B5) mancozeb, maneb, metam, metasulfocarb, methylam, felvam, Propinebu, tyram, dineb, ziram, dietofencarb, iprovaricarb, benchavaricarb, propamocarb, propamocarb hydrochloride, 4-fluorophenyl-N-(1-(1-(4-cyanophenyl)-ethanesulfonyl) but 2-yl) carbamate, carbamates including methyl-3-(4-chloro-phenyl)-3- (2-isoproxycarbonylamino-3-methyl-butyrylamino) propanoate; or B6) guanidine, dodine, dodine Free base, iminotadine, guazatine, antibiotics: kasugamycin, streptomycin, polyoxin, validamycin A, nitrophenyl derivatives: binapacryl, dinocup, dinobutone, sulfur-containing heterocyclic compounds: dithianone, isoprothiolane, organometallic compounds: fentin salts, organophosphorus compounds: Edifenphos, iprobenphos, fosetyl, fosetyl-aluminum, phosphorous acid and its salts, pyrazophos, tolcrofos-methyl, organochlorine compounds: dichlorofluanid, fursulfamide, hexachloro-benzene, phthalide, pencyclon, quintozene, thiophanate-methyl, tolylfluani And others: Cyflufenamide, Simoxanyl, Dimethylylmol, Ethymol, Flaxil, Metraphenone and Spiroxa, Guazatine-acetate, iminoctadine-triacetate, iminoctadine-tris (albesylate), kasugamycin hydrochloride hydrate, dichlorophen, pentachlorophenol and its salts, N-(4-chloro-2-nitro-phenyl)-N-Ethyl-4-methyl-benzenesulfonamide, dichlorane, nitrotar-isopropyl, technazen, biphenyl, bronopol, diphenylamine, myrdiomycin, oxine copper, prohexadione calcium, N-(cyclopropylmethoxyimino-(6-difluoromethoxy- 2,3-difluoro-phenyl)-methyl)-2-phenylacetamide, N′-(4-(4-chloro-3-trifluoromethyl-phenoxy)-2,5-dimethyl-phenyl)-N-ethyl-N-methylformamidine, N′-(4-(4-fluoro-3-trifluoromethyl-phenoxy)-2,5-dimethyl-phenyl)-N-ethyl-N-methylformamidine, N′-(2-methyl-5-trifluoromethyl-4-(3-trimethylsilanyl-propoxy)-phenyl)-N-ethyl-N-methylformamidine, and N′-(5-difluoromethyl-2-methyl-Other fungicides including 4-(3-trimethylsilanyl-propoxy)-phenyl)-N-ethyl-N-methylformamidine.

Nematicides or bionematicides: benomyl, cloetocarb, aldoxycarb, tilupert, diamidafos, fenamifos, kazusafos, diclofenthion, etoprophos, fensulfothione, phostiazete, heterophos, isamidophos, isazofos, phosphocarbimisiafos, phosphocarbimisiafos Mecalphone, Acetoprole, Benclothiaz, Chloropicrin, Dazomet, Fluenesulfone, 1,3-Dichloropropene (telone), Dimethyl disulfide, Metam sodium, Metam potassium, Metam salt (all produced MITC), Methyl bromide, Biological soil Improvement (eg, mustard seed, mustard seed extract), soil steam fumigation, allyl isothiocyanate (AITC), dimethyl sulfate, Fuaru (aldehyde).

Suitable plant growth regulators of the present invention include: Plant growth regulator: D1) antiauxin such as clofibric acid, 2,3,5-triiodobenzoic acid; D2) 4-CPA, 2,4-D, 2,4-DB, 2,4-DEP, di Chlorprop, fenoprop, IAA, IBA, naphthaleneacetamide, a-naphthaleneacetic acid, 1-naphthol, naphthoxyacetic acid, potassium naphthenate, sodium naphthenate, auxin such as 2,4,5-T; D3) 2iP, benzyladenine Cytokinins such as 4-hydroxyphenethyl alcohol, kinetin and zeatin; D4) dead leaves such as calcium cyanamide, dimethipine, endal, ethephone, melphos, methoxuron, pentachlorophenol, thiazulone and tribuphos; D5) abiglycine and 1-methyl Ethylene such as cyclopropene Inhibitors; D6) Ethylene-releasing agents such as ACC, etaceracyl, etephone, glyoxime; D7) Gametosides such as fenridazone and maleic acid hydrazide; D8) Gibberellins such as gibberellin and gibberellic acid; D9) Abscisic acid, ansimidol, butralin, Carbaryl, chlorophonium, chloroprofam, dikeglac, flumetralin, fluoride amide, fosamine, glyphosdine, isopyrimole, jasmonic acid, maleic hydrazide, mepiquat, piproctanyl, prohydrojasmon, profam, thiaojian, 2,3,5-Growth inhibitors such as triiodobenzoic acid; D10) morphactins such as chlorflurane, chlorfurenol, dichloroflurenol, flulenol; D11) chlormecote, dami Growth inhibitors such as nozide, flurprimidol, mefluidide, paclobutrazole, tetocyclase, uniconazole; D12) growth stimuli such as brassinolide, brassinolide-ethyl, DCPTA, forchlorfenuron, hymexazole, prosuler, triacontanol, etc. Agent: D13) Bacmedesh, benzofluor, buminafos, carvone, choline chloride, siobide, clofenset, cyanamide, cyclanilide, cycloheximide, cyprosulfamide, epocholeon, etizlozate, ethylene, fufenthiourea, fullerane), Heptopargyl, holosulf, inabenfide, caletazan, lead arsenate, metasulfocarb, prohexadione, pida Down, Shintofen, triapenthenol, plant growth regulators that have not been classified such as trinexapac.

In one embodiment, the crop protection agents of the present disclosure can comprise one or a combination of Imidacloprid, Bifenthrin, Metalaxyl, Tebuconazole, Azoxystrobin, Carboxin, Thiram, Fludioxonil, Myclobutanil, Mefenoxam, Sedaxane, Thiamethoxam, Phorate, Ipconazole or Abamectin.

The compositions, formulations, and methods of the present disclosure can be useful for controlling insect damage from one or more of the following list of plant pathogenic insects including, but not limited to,: plant pathogenic nematodes, Meloidogyne incognita, Heterodera glycines (SCN), Rotylenchulus reniformis, corn rootworm, western corn rootworm (WCR), northern corn rootworm (NCR), southern corn rootworm (SCR), aphids, Green peach aphid (Myzus persicae), Cotton aphid (Aphis gossypit), Diamondback moth (Plutella xylostella), Taro caterpillar (Spodoptera litura), Red flour beetle (Tribolium castaneum), Fall armyworm (Spodoptera frugiperda), and Brown planthopper (Nilaparvata lugens). Cowpea bruchid (Calloso-bruchus maculatus), European cornborer (Ostinia nubilalis), Tobacco hornworm (Manduca sexta), Stem borer (Chilo partellus), Rice brown plant hopper (Nilaparvata lugens), Rice green leaf hopper (Nephotettix cinciteps), Potato leaf hopper (Empoasca fabae), Peach potato aphid (Myzus persicae), Pea aphid (Acyrthosiphon pisum), Gout fly (Chlorop pumilionis), crickets, Locusts, termites, thrips, ants, Mites (Acarina), Lepidopteran (Mamestra brassicae), Wheat bulb fly (Delia coarctata), Cereal aphid (Sitobion avenae), and Colorado potato beetle (Leptinotarsa decemlineata).

The plants and plant seeds of the present disclosure can include, but are not limited to, corn vegetables, monocots, dicots, cotton, rice, soybean, tomato, cereals, root/tuber and brassica vegetables, cucurbit vegetables, bulb vegetables, citrus, fruiting vegetables, herbs/spices, leafy vegetables, legumes/vegetables (succulent and dried beans and peas), oil seed crops, sunflower, pome fruit, stone fruit, strawberry, sugarcane, sugarbeet, tree nuts, kiwi, banana, grass, ornamental plants, and hardwood cuttings. In some embodiments, the plant or plant seed is peanut.

The plant pathogens that can be controlled with the methods or coated seeds or plants of the present disclosure include, but are not limited to, one or more of plant pathogenic fungi, plant pathogenic nematodes, Meloidogyne incognita, Heterodera glycines (SCN), Rotylenchulus reniformis, Lesion nematode, corn rootworm, western corn rootworm (WCR), northern corn rootworm (NCR), southern corn rootworm (SCR), aphids, Green peach aphid (Myzus persicae), and Cotton aphid (Aphis gossypii). In one embodiment, the pathogen includes plant pathogenic fungi. In some embodiments, the pathogen comprises White mold (Sclerotium rolfsii) or Fusarium oxysporum.

As used herein, the phrase “a biologically pure culture” includes one or a combination of spores and vegetative cells of the biologically pure fermentation culture of the microbial strain. The phrase “biologically pure” means essentially biologically pure as it is understood in the art. In addition, “biologically pure culture” includes a mutant of the microbial strain having all the identifying characteristics thereof.

Following long-standing patent law convention, the terms “a,” “an,” and “the” refer to “one or more” when used in this application, including the claims. Thus, for example, reference to “a plant or a seed of a plant” includes a plurality of plants or seeds, unless the context clearly is to the contrary, and so forth.

Throughout this specification and the claims, the terms “comprise,” “comprises,” and “comprising” are used in a non-exclusive sense, except where the context requires otherwise. Likewise, the terms “having” and “including” and their grammatical variants are intended to be non-limiting, such that recitation of items in a list is not to the exclusion of other like items that can be substituted or added to the listed items.

For the purposes of this specification and claims, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range. In addition, as used herein, the term “about”, when referring to a value can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the disclosed compositions and methods. Alternatively, particularly with respect to biological systems or processes, the term can mean within an order of magnitude, preferably within 5-fold, and more preferably within 2-fold, of a value. Where particular values are described in the application and claims, unless otherwise stated, it should be assumed that the term “about” means within an acceptable error range for the particular value.

Throughout this specification and the claims, the phrase “microbial-, biological-, or chemical-crop protection agents” means any microbial, biological, or chemical agent that functions to protect crops against plant pests and/or plant pathogens including agents that function as one or more of a biocide, an insecticide, a fungicide, or a nematicide.

For the purposes of this specification and claims, the term “insect” includes nematodes.

For the purposes of the specification and claims, the phrase “foliage of a plant” means any plant part other than seed and roots.

The present invention will be described in more detail below through examples, but these examples are not intended to limit the present disclosure.

### EXAMPLES

### Example 1

Bacillus haynesii controls Fusarium oxysporum, White mold, and Agpergillus niger in Vitro

In vitro fungicidal testing was performed to evaluate Bacillus haynesii as a biofungicidal agent. For the experiments, a stock culture of Bacillus haynesii NRRL: B-41327 was obtained from the ARS Culture Collection and placed into 10ml of PBS buffer solution. 100 microliters were transferred to a TSA petri plate and evenly spread across the plate. The plates were incubated at 30 C and grown for 48 hours. A single colony was then used to create a 1× stock solution by inoculating a microcentrifuge tube containing 1000 microliters of PBS. The Fusarium oxysporum culture was obtained from Carolina Biological Supply and grown on a PDA plate at 3 0C for 48 hours. The White mold culture (Sclerotium rolfsil) was collected from the roots of a contaminated peanut plant growing in the greenhouse and grown on a PDA plate at 30 C for 48 hours. The Aspergillus niger culture was obtained from Carolina Biological Supply and grown on a PDA plate at 30C for 48 hours. A single colony was used to inoculate a 1000 microliter PBS solution to create a 1× stock solution of each fungus. 500 microliters of the Bacillus haynesii stock solution was transferred to 500 microliters of PBS to create entry 1. 500 microliters of Bacillus haynesii stock solution and 500 microliters of the fungal stock solution was transferred to a microcentrifuge tube to create entry 2. 500 microliters of the fungal stock solution was transferred to 500 microliters of PBS to create entry 3. The following treatments were performed in petri plates:
1. Bacillus haynesii
2. Bacillus haynesii+White Mold or Fusarium oxysporum or Aspergillus niger
3. White Mold or Fusarium oxysporum or Aspergillus niger

The results of the experiment with Fusarium oxysporum are shown in FIG. 1, the results with White mold are shown in FIG. 2, and the results with Aspergillus niger in FIG. 3. As can be seen in the images in FIGS. 1 and 2, the addition of Bacillus haynesii to the growth media containing the White mold or Fusarium oxysporum completely inhibited the growth of the fungus in both experiments. Specifically, the petri dishes containing the B. haynesii alone (top row of both FIG. 1 and FIG. 2) are indistinguishable from the petri dishes containing the B. haynesii in combination with the fusarium (middle row of FIG. 1) or the White mold (middle row of FIG. 2). This is in contrast to the plates inoculated with either White mold (bottom row of FIG. 1) or Fusarium oxysporum (bottom row of FIG. 2) alone where fungal growth has proliferated. In FIG. 3, the petri dishes containing the B. haynesii alone (top row) are indistinguishable from the petri dishes containing the B. haynesii in combination with the aspergillus niger (bottom row). In contrast, fungal growth has proliferated in the plates inoculated with Aspergillus niger alone (middle row).

### Example 2

Assay for Bacillus haynesii Control of Soybean Seedling Root Rot

Fungicidal testing is performed to evaluate Bacillus haynesii as a biofungicidal agent in control of seedling rot in soybean. For the experiments, replicated trays are completely randomized. The experimental trays are 14.5″ W×21.5″ L×5 ″ D in which 6=14.5″ furrows are planted. Each tray contains 2 designated treatments of 3 rows each as shown below:

### Treatments:

1. Soybean+Bacillus haynesii
2. Soybean Untreated
3. Soybean Untreated+Rhizoctonia solani
4. Soybean+Bacillus haynesii+Rhizoctonia solani
5. Soybean Untreated+Rhizoctonia solani
6. Soybean+Bacillus haynesii+Rhizoctonia solani
7. Soybean Untreated+Pythium irregulare
8. Soybean+Bacillus haynesii+Pythium irregulare
   There are 4 experimental replications of each treatment.

Growth conditions: Field soil is used as the growing substrate, plants are watered as needed, continual liquid feed fertilizer at 200 ppm NPK is used at every watering once seed have emerged. Greenhouse temperatures range from 18° C. to 25° C. and a watchdog unit is used to collect temperature data during the experiment. Automatic supplemental HID lighting provides additional light levels if outside weather conditions are overcast.

Data Parameters Collected: Seeding emergence data is taken at two timepoints during the experiment. Root disease severity is rated on each seedling using a disease severity rating scale of 1-7.
1=Healthy root development
2=Small lesion development
3=Coalesced lesion development, small reduction in root mass
4=Tap root rot, lesion development around root circumference, stubby roots (parameter dependent on pathogen used)
5=Severely reduced root mass and rot (parameter dependent on pathogen used
6=Weak root system (single root), severely stunted development, complete rot (parameter dependent on pathogen)
7=Seedling not emerged or seedling not functional for production Root and shoot dry weight are recorded and photos taken of representative treatments.

### Example 3

In Vitro Assay for Bacillus haynesii Control of Plant Fungal Pathogens

Testing is performed to evaluate Bacillus haynesii as a biofungicidal agent against plant fungal pathogens Rhizoctonia solani, Fusarium oxysporum, and Pythium irregulare. For the experiments, five replications of each treatment combination are plated on ½ strength PDA and TSA agar as shown below:

### Treatments:

1. Rhizoctonia solani control (alone)
2. Rhizoctonia solani with Bacillus haynesii
3. Fusarium oxysporum control (alone)
4. Fusarium oxysporum with Bacillus haynesii
5. Pythium irregulare control (alone)
6. Pythium irregulare with Bacillus haynesii

Data Parameters Collected: Digital calipers are used to measure in mm the distance the pathogen has grown toward the biological treatment (3× time point measurements) in comparison to the growth of the pathogen without biological treatment.

Digital scans of the experimental plates are taken at 1× timepoint for each treatment and all replicate plates.

Growth Conditions: Plates are incubated in the dark at 28° C.

### Example 4

Assay for Bacillus haynesii Inhibition of Nematode Hatching In Vitro

An in vitro experiment is performed to evaluate the effect of Bacillus haynesii in the control of three different phytonematode species Heterodera glycines, Meloidogyne incognita, and Rotylenchulus reniformis. Nematode eggs are grown in hatching chambers and treated with varying dosage of Bacillus haynesii spores for 10 days.

### Experimental Treatments:

1. Control: Water
2. Bacillus haynesii@0.0256 1 L/ha (corresponding to 5.5×10⁶ CFU in 50 ml)
3. Bacillus haynesii@0.1428 5 L/ha (corresponding to 2.75×10⁷ CFU in 50 ml)
4. Bacillus haynesii@0.3333 10 L/ha (corresponding to 5.5×10⁷ CFU in 50 ml)

Lyophilized Bacillus haynesii is dispersed in water to provide a concentrate solution (108 CFU/ml), which is diluted in a total of 50 milliliters resulting in the three different concentrations shown above. Each of the 50 ml solutions is applied to the 3 different species of nematode eggs present in petri dishes and left for 10 days. The eggs are microscopically evaluated to obtain hatching counts.

### Example 5

Assay for Bacillus haynesii Nematode Killing In Vitro

An in vitro experiment is performed to evaluate the effect of Bacillus haynesii on four different phytonematode species Heterodera glycines, Meloidogyne incognita, Rotylenchulus reniformis and Lesion nematode in comparison to the chemical nematicide Avicta. Nematodes are placed in petri dishes and treated with Avicta, water, or Bacillus haynesii spores for 48 hours as described below.

### Experimental Treatments:

1. Avicta (syngenta, 0.031%)
2. Control: Water
3. Bacillus haynesii@0.3333 10 L/ha (corresponding to 5.5×10⁷ CFU in 50 ml)

Lyophilized Bacillus haynesii is dispersed in water to provide a concentrate solution (10⁸ CFU/ml), which is diluted in a total of 50 milliliters. Avicta is similarly diluted into 50 ml and each of the treatments (1)-(3) above is applied to the 4 different species of nematode eggs present in petri dishes and left for 48 hr. Mortality is evaluated by stereoscopic microscopy. Nematodes that show any mobility or appear as winding shapes are considered alive and if nematodes do not show any movement and their body shape is straight, they are counted as dead.

### Example 6

Corn Field Trials of Bacillus haynesii- and Chemical Insecticide/fungicide-Treated Corn Seed

Corn field trials are conducted to evaluate the efficacy of seed treated with Bacillus haynesii alone and in combination with chemical insecticides and fungicides for the ability to reduce corn rootworm (CRW) damage and increase yield. The trials are performed in fields heavily infested with CRW. In the trial, the chemical insecticides and fungicides are applied at the label rate. Corn stand count, root injury mean score, and yield are determined.

### Treated Corn Seed Groups Are As Follows:

1. Fungicide (Azoxystrobin, Metalaxyl, Tebuconazole, Vitavax (Carboxin 37.5%+Thiram 37.5% DS))+Insecticide (Bifenthrin@3.6 FL. Oz./CWT, Imidacloprid@4.8 FL. Oz./CWT)
2. Bacillus haynesii (2.00 FL. Oz./CWT)+Fungicide (Azoxystrobin, Metalaxyl, Tebuconazole, Vitavax (Carboxin 37.5%+Thiram 37.5% DS))+Insecticide (Bifenthrin@3.6 FL. Oz./CWT, Imidacloprid@4.8 FL. Oz./CWT)
3. Bacillus haynesii (2.00 FL. Oz./CWT)+Fungicide (Azoxystrobin, Metalaxyl, Tebuconazole, Vitavax (Carboxin 37.5%+Thiram 37.5% DS)
4. Bacillus haynesii (2.000 Fl. Oz./CWT)
   The field trials are performed in the form of a randomized complete block with four replicates of each of the treatments. The planting population is 4 replicate rows (30-inch row spacing) with 5 feet of unplanted alley between plots. Stand count is recorded 30-45 days after planting and root node-injury score is recorded 60-70 days after planting.

Method of seed treatment with Bacillus haynesii. Bacillus haynesii are dispersed in water or liquid fertilizer such as a liquid fertilizer containing 89.9% by weight soy protein hydrolysate having 4% soluble nitrogen and 0.15% by weight chelated ferrous sulfate to a concentration of 7.0×10⁹ CFU per milliliter. Bacillus haynesii liquid is applied to corn seed at a rate of either two or three fluid ounces per hundred pounds of corn seed (designated “2.000 Fl. Oz./CWT” and “3.000 FI. Oz./CWT”, respectively).

Stand counts and plant heights are recorded at least once during the early vegetative period. Plots are monitored for early season pests, and if natural infestations occur data are collected across all plots. Corn root systems (5 per plot) are collected, washed, and rated for corn rootworm damage using the 0-3 node-injury scale; the timing of this rating is based on estimates of peak damage determined using degree days and preliminary evaluations of untreated plots. Yields are recorded from 2 rows using a plot harvester. Data are subjected to analysis of variance and post-hoc means separation.

Accordingly, while the compositions and methods have been described in reference to specific embodiments, features, and illustrative embodiments, it will be appreciated that the utility of the subject matter is not thus limited, but rather extends to and encompasses numerous other variations, modifications and alternative embodiments, as will suggest themselves to those of ordinary skill in the field of the present subject matter, based on the disclosure herein.

Various combinations and sub-combinations of the compositions, methods, and features described herein are contemplated and will be apparent to a skilled person having knowledge of this disclosure. Any of the various features and elements as disclosed herein may be combined with one or more other disclosed features and elements unless indicated to the contrary herein. Correspondingly, the subject matter as hereinafter claimed is intended to be broadly construed and interpreted, as including all such variations, modifications and alternative embodiments, within its scope and including equivalents of the claims.

No admission is made that any reference, including any non-patent or patent document cited in this specification, constitutes prior art. It will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinence of any of the documents cited herein. All references cited herein are fully incorporated by reference, unless explicitly indicated otherwise. The present disclosure shall control in the event there are any disparities between any definitions and/or description found in the cited references.

1-19. (canceled)

20. A method for controlling pathogen damage to a plant, the method comprising:
planting a plant or a seed of a plant in a suitable growth medium, the plant or the seed having a coating or partial coating of a composition comprising:
a biologically pure culture of a Bacillus haynesii NRRL B-41327, or a mutant thereof having all the identifying characteristics thereof; and
optionally, one or more carriers, excipients, nutrients, plant growth regulators, or microbial-, biological-, or chemical-crop protection agents,
wherein the Bacillus haynesii NRRL B-41327 is present in the composition in an amount suitable to improve plant yield or reduce plant pathogen damage in the presence of a plant pathogen, or both.

21. A method for controlling pathogen damage to a plant, the method comprising:
delivering to seed of a plant, foliage of a plant, roots of a plant, or soil or growth medium surrounding a plant, a composition comprising:
a biologically pure culture of a Bacillus haynesii NRRL B-41327, or a mutant thereof having all the identifying characteristics thereof; and
optionally, one or more carriers, excipients, nutrients, plant growth regulators, or microbial-, biological-, or chemical-crop protection agents,
wherein the Bacillus haynesii NRRL B-41327 is present in the composition in an amount suitable to improve plant yield or reduce plant pathogen damage in the presence of a plant pathogen, or both.

22. The method of claim 20, wherein the Bacillus haynesii NRRL B-41327 is present on the seed in an amount ranging from 1.0×10¹² CFU/g to 1.0×10¹ CFU/g, from 9.0×10⁷ CFU/g to 2.0×10⁴ CFU/g, or from 4.0×10⁸ CFU/g to 1.0×10⁴ CFU/g seed.

23. The method of claim 20, wherein the crop protection agents comprise one or a combination of Imidacloprid, Bifenthrin, Metalaxyl, Tebuconazole, Azoxystrobin, Carboxin, Thiram, Fludioxonil, Myclobutanil, Mefenoxam, Sedaxane, Thiamethoxam, Ipconazole or Abamectin.

24. The method of claim 21, wherein the composition is in the form of a liquid and the Bacillus haynesii NRRL B-41327 is present at a concentration ranging from 1.0×10¹² to 1.0×10¹ CFU/ml, 1.0×10¹¹ CFU/ml to 1.0×10² CFU/ml, or from 1.0×10¹⁰ CFU/ml to 1.0×10⁴ CFU/ml.

25. The method of claim 21, wherein the composition is in the form of a dust, a dry wettable powder, a spreadable granule, or a dry wettable granule and the Bacillus haynesii NRRL B-41327 is present in an amount ranging from 1.0×10¹² CFU/g to 1.0×10¹⁰ CFU/g, from 5.0×10¹¹ CFU/g to 1.0×10³ CFU/g, or from 1.25×10¹¹ CFU/g to 1.0×10⁸ CFU/g.

26. A method of plant or plant seed treatment comprising applying to a plant or seeds of a plant a coating of a composition comprising:
a biologically pure culture of a Bacillus haynesii NRRL B-41327, or a mutant thereof having all the identifying characteristics thereof; and
optionally, one or more carriers, excipients, nutrients, plant growth regulators, or microbial-, biological-, or chemical-crop protection agents, wherein the Bacillus licheniformis K-357 is present in the composition in an amount suitable to improve plant yield or reduce plant pathogen damage in the presence of a plant pathogen, or both.

27. The method of claim 26, wherein the Bacillus haynesii NRRL B-41327 is applied to the seed in an amount ranging from 1.0×10¹² CFU/g to 1.0×10¹ CFU/g, from 9.0×10⁷ CFU/g to 2.0×10⁴CFU/g, or from 4.0×10⁸ CFU/g to 1.0×10⁴ CFU/g seed.

28. The method of claim 26, wherein the coating is applied to the plant foliage, the plant root tips, or the plant transplant roots.

29. The method of claim 26, wherein the crop protection agents comprise one or a combination of Imidacloprid, Bifenthrin, Metalaxyl, Tebuconazole, Azoxystrobin, Carboxin, Thiram, Fludioxonil, Myclobutanil, Mefenoxam, Sedaxane, Thiamethoxam, Phorate, Ipconazole or Abamectin.

30. A plant or a seed of a plant having a coating of a composition comprising:
a biologically pure culture of a Bacillus haynesii NRRL B-41327 or a mutant thereof having all the identifying characteristics thereof; and
optionally, one or more carriers, excipients, nutrients, plant growth regulators, or microbial-, biological- or chemical-crop protection agents, wherein the Bacillus haynesii NRRL B-41327 is present in the composition in an amount suitable to improve plant yield or reduce plant pathogen damage in the presence of a plant pathogen, or both.

31. The plant or the seed of claim 30, wherein the Bacillus haynesii NRRL B-41327 is present in the composition on the seed in an amount ranging from 1.0×10¹² CFU/g to 1.0×10¹ CFU/g, from 9.0×10⁷ CFU/g to 2.0×10⁴ CFU/g, or from 4.0×10⁸ CFU/g to 1.0×10⁴ CFU/g seed.

32. The plant or the seed of claim 30, wherein the crop protection agent comprises one or a combination of Imidacloprid, Bifenthrin, Metalaxyl, Tebuconazole, Azoxystrobin, Carboxin, Thiram, Fludioxonil, Myclobutanil, Mefenoxam, Sedaxane, Thiamethoxam, Phorate, Ipconazole or Abamectin.

33. The plant or the seed of claim 30, wherein the plant foliage, the plant root tips, or the plant transplant roots have the coating.

34. The method of claim 20, wherein the plant comprises one or more of corn vegetables, monocots, dicots, cotton, rice, soybean, tomato, cereals, root/tuber and brassica vegetables, cucurbit vegetables, bulb vegetables, citrus, fruiting vegetables, herbs/spices, leafy vegetables, legumes/vegetables (succulent and dried beans and peas), oil seed crops, sunflower, pome fruit, stone fruit, strawberry, sugarcane, sugarbeet, tree nuts, kiwi, banana, grass, ornamental plants, or hardwood cuttings.

35. The method of claim 20, wherein the plant comprises peanut plants.

36. The method of claim 20, wherein the pathogen comprises plant pathogenic fungi, plant pathogenic nematodes, Meloidogyne incognita, Heterodera glycines (SCN), Rotylenchulus reniformis, Lesion nematode, corn rootworm, western corn rootworm (WCR), northern corn rootworm (NCR), southern corn rootworm (SCR), aphids, Green peach aphid (Myzus persicae),or Cotton aphid (Aphis gossypii), and combinations thereof.

37. The method of claim 20, wherein the pathogen comprises plant pathogenic fungi.

38. The method of claim 20, wherein the pathogen comprises Sclerotium rolfsii or Fusarium oxysporum.
